(19) United States
(12) Patent Application Publication
(10) Pub. No.: US 2013/0317797 A1
(43) Pub. Date: Nov. 28, 2013

(54) DIRECT ATTACHMENTS TO PROXY BODIES

(71) Applicants: Richard Gary McDaniel, Hightstown, NJ (US); Lingyun Lu, Diamond Bar, CA (US)

(72) Inventors: Richard Gary McDaniel, Hightstown, NJ (US); Lingyun Lu, Diamond Bar, CA (US)

(73) Assignee: SIEMENS PRODUCT LIFECYCLE MANAGEMENT SOFTWARE INC., Plano, TX (US)

(21) Appl. No.: 13/868,701

(22) Filed: Apr. 23, 2013

Related U.S. Application Data
(60) Provisional application No. 61/650,045, filed on May 22, 2012.

(51) Int. Cl. G06F 17/50

(52) U.S. Cl. CPC G06F 17/5009
USPC 703/6

(57) ABSTRACT

Methods for part model generation and simulation and corresponding systems and computer-readable mediums. A method includes receiving a part model and creating at least one rigid body corresponding to the part model. The method includes creating at least one proxy body corresponding to the part model, including directly attaching at least one proxy body to at least one rigid body, wherein the proxy body represents a rigid body that is not part of the part model. The method includes simulating the part model by the data processing system according to the corresponding rigid bodies and proxy bodies.

### CROSS-REFERENCE TO OTHER APPLICATION

This application claims the benefit of the filing date of U.S. Provisional Patent Application 61/650,045 for “Making Direct Attachments to Configure Proxy Bodies”, filed May 22, 2012, which is hereby incorporated by reference.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved systems are desirable.

### SUMMARY OF THE DISCLOSURE

Various disclosed embodiments include part model generation and simulation and corresponding systems and computer-readable mediums. A method includes receiving a part model and creating at least one rigid body corresponding to the part model. The method includes creating at least one proxy body corresponding to the part model, including directly attaching at least one proxy body to at least one rigid body, wherein the proxy body represents a rigid body that is not part of the part model. The method includes simulating the part model by the data processing system according to the corresponding rigid bodies and proxy bodies.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIGS. 2 and 3 illustrate examples of an assemblage of CAD parts in accordance with disclosed embodiments;

FIG. 4 illustrates a configuration of simulation objects in accordance with disclosed embodiments;

FIG. 5 illustrates a solution with defined physics objects in accordance with disclosed embodiments;

FIG. 6 illustrates an example of how physics for a part can be defined using a proxy body as disclosed herein;

FIG. 7 illustrates geometry and physics objects in an example of the inclusion of two parts together, in accordance with disclosed embodiments;

FIG. 8 illustrates a diagram of a part with physics objects including a collision object, in accordance with disclosed embodiments;

FIG. 9 illustrates combining two parts in accordance with disclosed embodiments;

FIG. 10 illustrates an exemplary dialog for entering properties to define a proxy object as disclosed herein;

FIG. 11 illustrates an example dialog for setting the attachment of a proxy override as disclosed herein; and

FIG. 12 depicts a flowchart of a process in accordance with disclosed embodiments.

### DETAILED DESCRIPTION

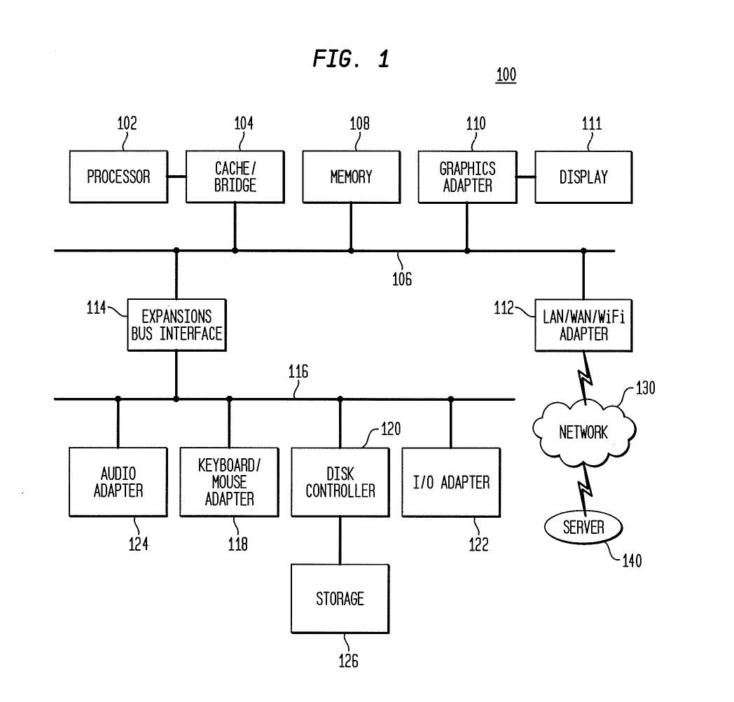

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include systems and methods for specifying new simulation objects in the context of a three-dimensional CAD-like engineering tool or other PDM system. Such processes are used to define the contents and interface for the objects as a list of properties, but also allows for the object to be moved or transformed by simulation physics. In various embodiments, a proxy object is overridden so that it becomes parameterized by an actual rigid body. Instead of relying solely on the rigid body and the proxy sharing geometric objects, a new, direct attachment field is added to the proxy so that the proxy may point to rigid body used to as its replacement.

According to various embodiments, a proxy body can include one or more of the following aspects. A runtime behavior aspect is described by a set of named parameters. A runtime behavior override aspect allows the values of the set of named parameters to be overridden in its instance. An encapsulated geometry aspect allows a proxy body to reference a set of geometry. An attachment rigid body aspect allows an instance of a proxy body to be attached to a rigid body. In this case, the encapsulated geometry of the proxy body can move with the rigid body during simulation. Otherwise, the proxy body can be static.

FIG. 1 depicts a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

As described in more detail below, disclosed embodiments include a proxy body and its associated parameters that can be stored in a Product Data Management (PDM) system, enabling editing of the parameters in either the CAD system or the PDM system. The proxy object can be overridden so that it becomes parameterized by an actual rigid body. A direct attachment field can be associated with the proxy so that it can point to a rigid body used as its replacement.

When using a proxy body in a simulation, the proxy body can behave as a static body, unmoving in the simulation, if it is not connected to any rigid body. When the proxy body is connected to a rigid body, the encapsulated geometry of the proxy body can move with the rigid body it is connected (or attached) to.

The proxy body can “reference” upwards into the assembly tree through the use of the attachment rigid body. This behavior is not possible without a proxy body as disclosed herein.

With the creation of the proxy body, it is possible for users to build reuse parts that contain joints and other mechanisms where part of the objects that the joint connects to can come from the parts that include the reuse parts as components. This could potentially save users the time, the cost and standardize the process

The override behavior in the proxy body allows users to alter the instances of the proxy body to be different than the original proxy body.

The proxy body techniques disclosed herein can easily be extended and incorporated in a PDM system. In this case, when authoring (which is generally performed in the CAD system, since geometry identification is required), the parameters in the proxy body are saved and can then be modified from within the PDM system alone. When the part containing the proxy body is retrieved from the PDM system into the CAD system, the parameters that were modified using the PDM system will be reflected in the CAD system. Similarly, persisted edits performed in the CAD system would also be reflected in the PDM system.

In CAD data, multiple data entities, perhaps stored in files and often called parts, can be associated together to form a composite object. Each data entity (or part) can potentially be reused in different contexts and different assemblies to save the engineer the effort from having to draw all entities from primitive operations.

The method for incorporating the reusable parts involves importing the data entity into the context of another. The part in which the data is imported can be called an assembly and the imported data can be called a component, but the difference between a component and an assembly is just the manner in which the data entities are connected. A given part may act as an assembly for some parts and as a component for other parts. The method to achieve the actual data import may involve copying all the data from the component part into the assembly thereby making the copied data in the assembly independent from the original data.

The import may also be performed by reference, in which case the original part is the sole container for the data being shared. In this case, if the data in the part is modified, either independently or from the assembly, all copies of that part's data within the assembly are seen to be modified. For the purposes of this disclosure, the referenced part file method will be assumed though the techniques disclosed herein can be applied equally to either case.

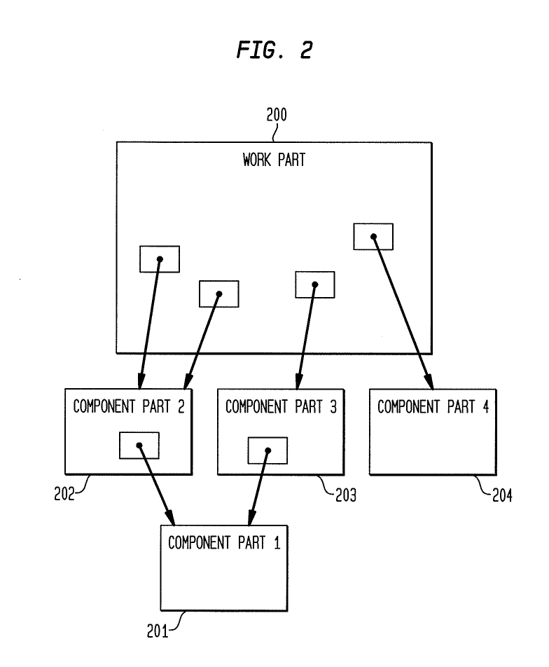

FIG. 2 illustrates an example of an assemblage of CAD parts that demonstrates how parts can be reused as components. FIG. 2 illustrates an exemplary arrangement of parts that might be found in CAD data. In the diagram, each box represents a part. There is a common direction between a component and the owner of that component. A part cannot be a component of itself. Likewise, a part is not allowed to be a component of a part that is a component of itself and so on. The boxes with dotted lines represent the use of the part within the context of the assembly. A component may be included multiple times as many as are needed to represent the multiple instances of the same geometry in the assembly. The examples herein refer to piston and crankshaft assemblies, but, of course, the disclosed techniques are not limited to these examples.

In this figure, component part 2 202 is included twice into work part 200. A part may also be used as a component for different assemblies. In this figure, component part 1 201 is included in component part 2 202 and component part 3 203. Since those parts are included in work part, there are effectively three references to component part 1 included in the work part. Component part 4 204 is included only in work part 200 in this example.

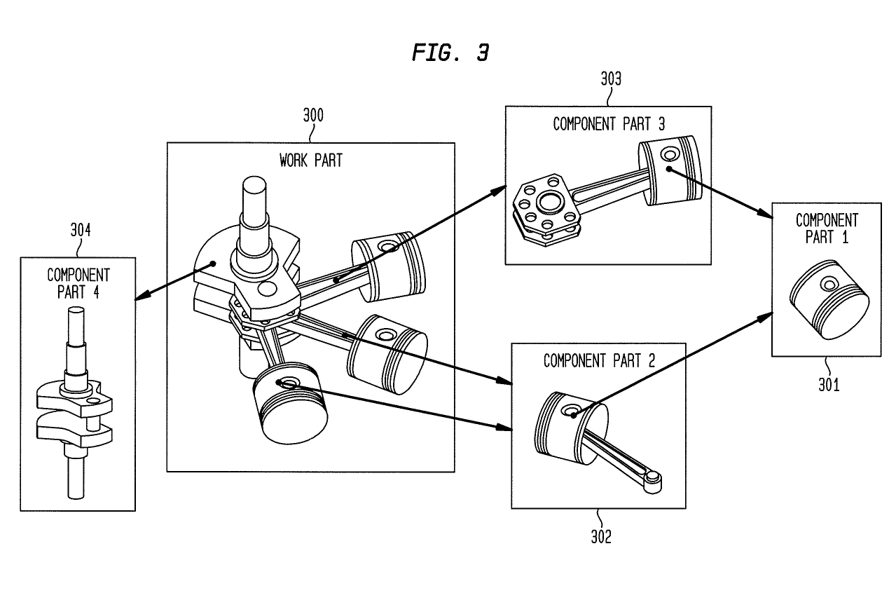

FIG. 3 illustrates the same configuration of parts except the geometric contents of the parts are made evident. The example shows a crankshaft (as component part 4 304) and set of pistons (component part 3 303 and component part 2 302), all part of the crankshaft assembly represented by work part 300. Each of the components of the data is separated into logical entities as might be realized in an actual CAD assembly. The crankshaft is component part four 304. The cylinder head (component part 1 301) is shared by a standard piston (component part 2 302) as well as the master piston (component part 3 303). The standard pistons are replicated twice here (and would be replicated four more times if the example would be complete).

Simulation Objects: Traditional CAD is concerned with representing plans and diagrams used for constructing various products. Three-dimensional CAD is used to represent 3D geometry such as surfaces, solids, and geometric constraints. More recently, the ability to simulate various product activities such as movement and kinematics is made available in CAD tools. For example, multi-body simulation can be applied to the geometric entities described in CAD data that allow for the motions of the represented objects to be calculated and analyzed. Animation of the motions can be recorded and played back so that they can be visualized. This disclosure will use a particular implementation of multi-body physics for its example with the understanding that the techniques described herein can generalize to other kinds of simulation systems.

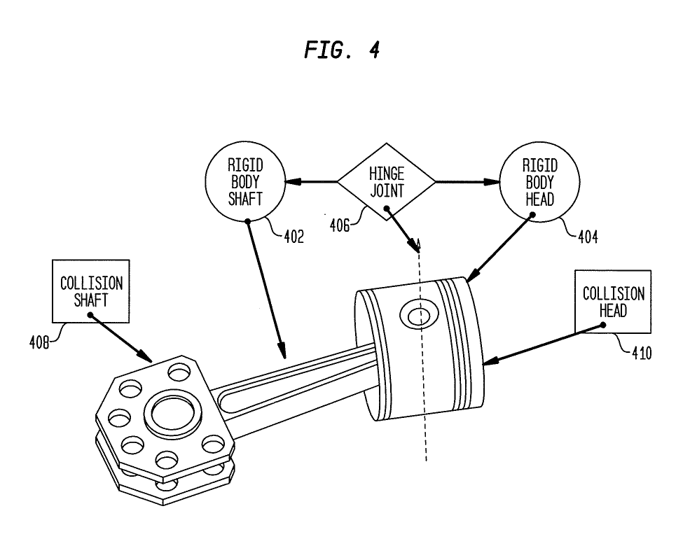

FIG. 4 illustrates a configuration of simulation objects that might be attached to a cylinder head and shaft configuration to represent its physical activity. Five physics objects are shown. The two circles represent rigid body objects, as rigid body shaft 402 and rigid body head 404. Rigid bodies represent things that move in the simulation. There is one rigid body attached to the shaft and another rigid body attached to the head because each of these geometric entities can move independently. The arrow with a dot indicates the connection between the geometric data element in the CAD and the rigid body physics object. This allows the system to know properties of the rigid body such as its mass and initial position and also indicates what graphical objects to animate when the simulation is to be visualized.

The diamond shaped box indicates a hinge joint 406 between the head 404 and shaft 402. This means that the motions between the head body and the shaft body are constrained so that they are always connected and can be twisted along the axis shown as a dotted arrow. The two rectangle boxes—collision shaft 408 and collision head 410—represent collision surfaces, one for each geometric entity. A collision physics object represents that a given shape will collide with another if they are brought together. In this case, since the shaft collision object 408 shares the same geometry as the shaft rigid body (the shaft geometry), the collision surface of the shaft will move with the rigid body of the shaft allowing it to collide with other physical objects in the simulation such as the cylinder head.

The physics objects refer to one another as well as to geometry within the part. In the example, the hinge joint references each of the two rigid bodies. The shaft rigid body and collision surface reference the shaft geometry and the head rigid body and head collision surface reference the cylinder head geometry. When applied to a CAD assemblage with multiple parts, it imposes constraints on where certain physics object can be created. For example, in some systems, a joint defined in component part 1 would not be able to refer to a rigid body defined in component part 3. This is because component part 3 is the owner of component part 1 and the linkage would be going backwards in the hierarchy. Going the other way, a hinge joint in component part 3 is able to refer to a rigid body in component part 1 because all parts of a component are known and available to the owner.

One solution is to live with this limitation or to enforce the separation of physics objects from geometry.

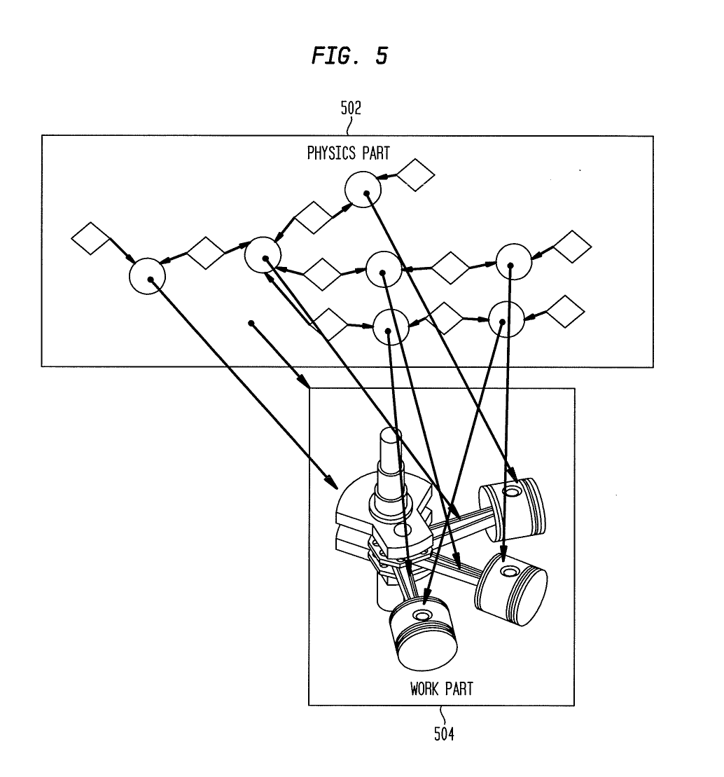

FIG. 5 illustrates such a solution where all physics objects are defined in a unique part that is the owner of the top-most part that defines geometry. In this figure, the bolded arrow indicates that physics/simulation part 502 is associated with work part 504. Note that all the rigid bodies (circles) represented in the simulation part 502 are associated with respective parts of the work part 504.

Even with this small example, it is clear that the number of physics objects that must be defined can be significant and that there is an advantage for storing the physical objects in the parts so that they may be reused. Physics objects may be distributed to the component parts but the constraints and actuators that control connections between objects must always be put in parts that are owners of the parts being controlled. This forces joint definitions up and out from the part where the geometry is defined and into the part where the geometry is used. Since the majority of the physical semantics and complexity of the physical system are represented by the joints and other kinds of connections, this would put a limitation on the advantage for storing physics objects in parts.

Proxy Body Definition: Disclosed embodiments define proxy body objects to serve as stand-ins for rigid body objects in a component. This allows connecting physics objects to be stored in component parts and still be able to be connected to objects in owner parts and other parts in the hierarchy. A proxy body may also be referred to as a proxy object herein.

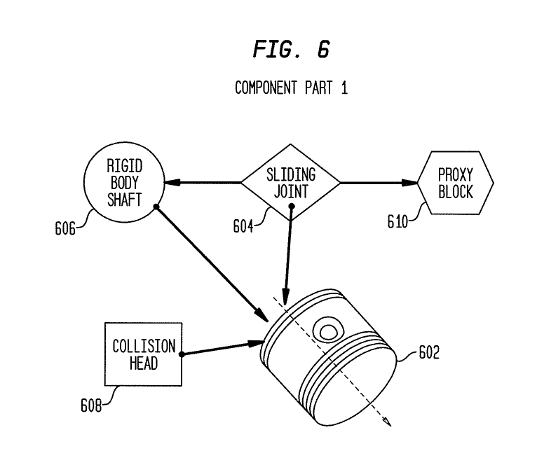

FIG. 6 illustrates an example of how the physics for the cylinder head part might be defined using a proxy body as disclosed herein. The work part for cylinder head 602 is associated, in the simulation model, with sliding joint 604 (represented by the dotted axis), rigid body head 606, and collision head 608. From the “perspective” of the cylinder head 602, the geometry representing the piston shaft and the geometry representing the engine block do not exist. These geometries could be defined in other parts and might be defined using one of many different possible designs. However, the relationship of the cylinder to the engine block can be created locally in the cylinder part. In this example, the system maintains a proxy object 610 that represents the engine block. In this case, the cylinder would be connected to the block via sliding joint 604 (a standard linear joint). This is shown as sliding joint 604 connecting rigid body head 606 and the proxy object 610.

If the user runs the cylinder part in simulation, the rigid body for the cylinder would be free to move along the sliding joint. Because no rigid body is defined for the engine block, the base of the sliding joint is treated as connected to the background. The cylinder does not fall, but slides on the joint connected to the background.

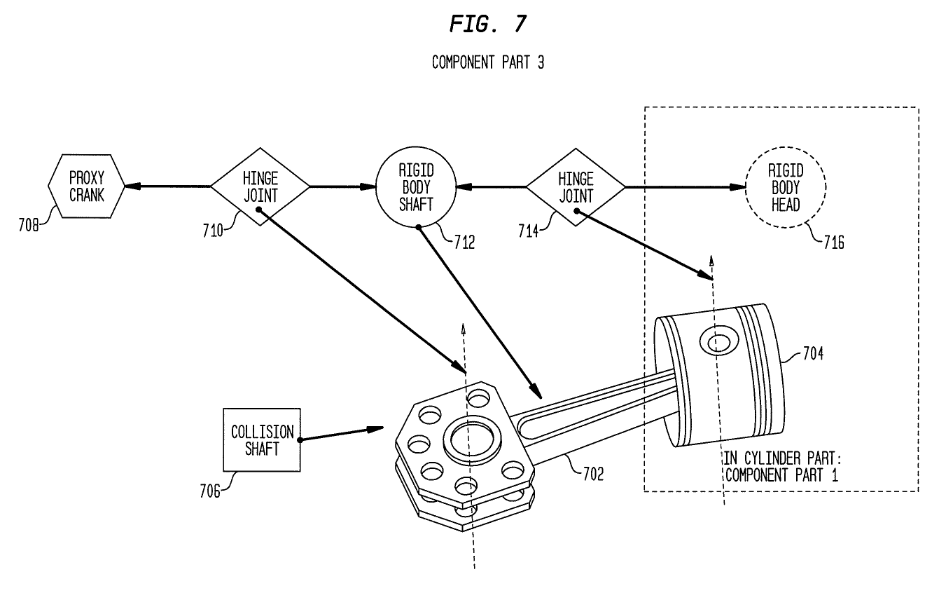

FIG. 7 illustrates geometry and physics objects for the master piston part 702 as an example of the inclusion of two parts together. The master piston 702 imports a cylinder head object 704 and thereby can use the geometry and physics defined in that component in its own definition. Here a hinge joint 714 is created between rigid body objects for the piston shaft 712 and the cylinder head 704 (represented in the simulation as rigid body head 716). Similarly, a hinge joint 710 is created between the rigid body shaft 712 and the crank proxy body 708. In cases where the joint or other semantic objects can be defined in the assembly part, proxy objects need not be applied. The rigid body 716 for the cylinder head is in the component and is accessible from the master piston part where the hinge is defined. The user has the option of defining the hinge in the assembly so that a proxy body is not needed or in the component where a proxy would be used to refer to the optional rigid body being connected to. A collision shaft 706 is maintained as a collision object for the piston shaft.

For the connection of the piston to the crank of the engine, the crank is still another part and is not defined in the master piston part.

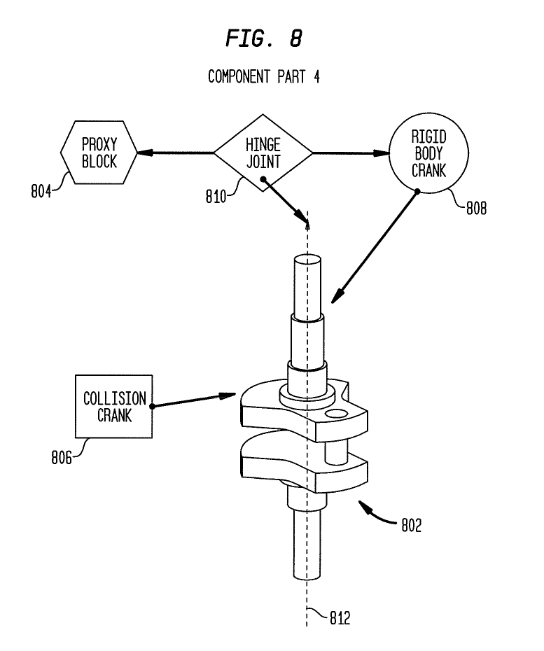

FIG. 8 illustrates a diagram of the crankshaft part 802 with physics objects, including its collision object 806. A proxy object 804 is defined for a connection to the engine block if the user desires to use it, in which case the crank rigid body 808 is connected to the proxy object 804 by a hinge joint 810. Running the simulation of the crankshaft 802 by itself allows the crankshaft to turn along its axis 812 connected to the background.

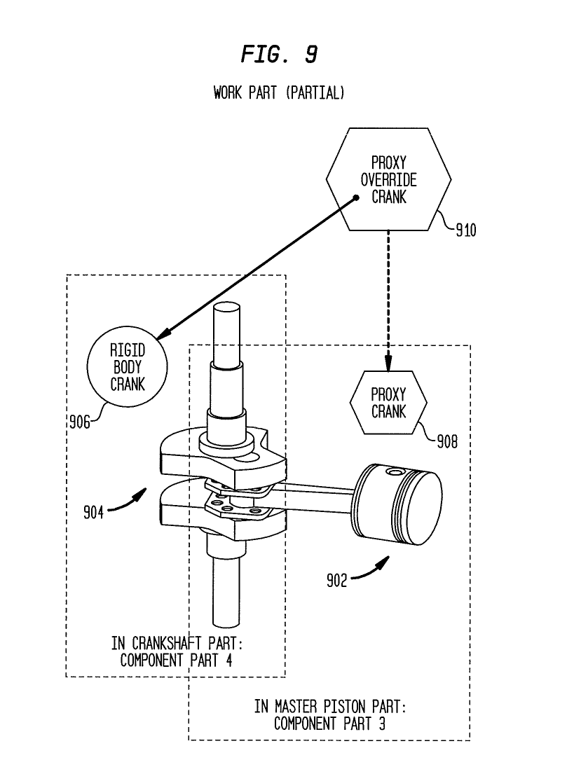

FIG. 9 illustrates combining the master piston 902 with the crankshaft 904. Here the user wants the piston to be connected to the crankshaft using the ready-made hinge joint (not shown). In this example, the rigid body 906 to which the piston connects is neither in the master piston parts, nor is it in the owner part. The rigid body 906 is in a sibling part, the crankshaft's rigid body 906. According to disclosed embodiments, the example shows how the proxy body's object in the master piston part, “Proxy Crank” 908, is over-ridden using a proxy override object 910. A proxy override is created with respect to a proxy body object stored in a part. In this case, the crank proxy object is used to define a proxy override object that is then connected to the rigid body object in the crankshaft part.

The ability for the override to connect across part boundaries is a significant feature of disclosed embodiments. If one relied only on the definition of rigid body objects, it would only be possible to parameterize a proxy body for parts that are a child of the part containing the rigid body.

By using the proxy override, instead, the link can be made easily across various configurations of parts.

Proxy Body Semantics: A proxy body is referred to herein as a “proxy” because it acts as a stand-in for a rigid body. This provides a significant advantage in reusable parts scenarios, where the presence of an actual rigid body in the part intended to be reused is not possible. In the piston and crankshaft example, allowance was made for an engine block component and yet none was made available. In a different example, the engine block may be an element of the simulation. With the engine, it is still important, from a simulation standpoint, for the parts to move in relation to one another as they would if the engine block were present.

Running the assembly of crankshaft and pistons without the block, one would expect the object to stay in place. The crankshaft would turn on its rotary hinge joint and the cylinders would slide on their linear sliding joints. The user would not expect the objects to fall down but would stay attached to the background. However, if the engine block's rigid body were defined, then the crankshaft's rotation axis and the cylinders' sliding axes would need to be connected to the motion of the block. If the engine moves, the internal parts would move with it. If some parts were connected to the background, they would pin the engine block down and not allow it to move properly.

In a programming sense, the proxy body acts as a parameter for a reusable part. The parameter takes a rigid body as its value and inserts the rigid body as the value for all objects within the part connected to that proxy body.

Proxy Body Structure: The proxy body as defined in the invention is an object and defines several properties that the user can set. The key trait of the proxy body is that it will exist in the part such that other objects can use it for reference. The proxy body's properties are a set of user-defined name-value attribute pairs, a set of geometric objects, and a set of physics objects. These properties are optional and the user can set up what is needed without needing to use everything.

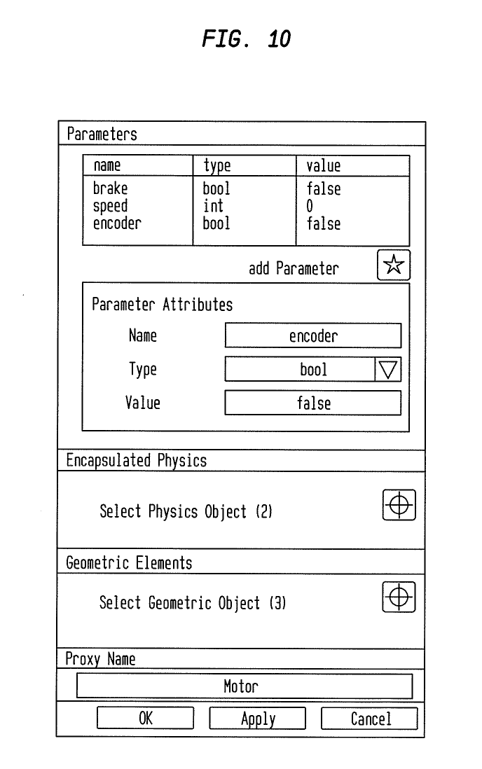

FIG. 10 illustrates an exemplary dialog for entering these properties to define a proxy object as disclosed herein. As shown in this example, the system can prompt a user and receive such information for the proxy body as parameters and parameter attributes with associated names, types, values, encapsulated physics, geometric elements, a proxy name, and other information.

The geometry list acts the same as it would for a rigid body object. The rigid body semantically provides for the ability that objects move in the simulation. The list of geometric objects stored in a rigid body defines which geometric objects are to move. A proxy body does not move on its own, but its geometric objects move if connected to a rigid body that moves. The list of geometric objects stored in the proxy body will move with whatever rigid body to which it is connected.

The system can also use shared geometry to determine how collision surfaces and trigger areas behave in the simulation. A collision surface is attached to a list of geometric objects and determines constraints that prevent pairs of collision surfaces from intersecting. A trigger is also attached to a list of geometric objects. The behavior of a trigger in simulation is that it reacts when objects with collision surfaces pass through the volume of the attached geometry. When a rigid body and a trigger or collision surface share one or more geometric objects, the attached object will move with the rigid body. A trigger or collision surface who shares geometry with no rigid body is static.

When the trigger or collision surface shares geometry with a proxy body, the semantics are that they remain static if the proxy body is not attached to a rigid body. If the proxy body is attached to a rigid body, then the collision surfaces and triggers associated with that proxy body will move with the attached rigid body.

The name-value attribute pairs and the list of physics objects are used to provide an interface via the proxy that can be used to interact with the reuse part. These do not necessarily affect the simulation behavior with respect to rigid bodies.

Proxy Override: The proxy override need not be displayed as a separate entity from the proxy body's definition. From the user's perspective, creating an override may be seen as editing the proxy body from the owner part. Regardless of how it is presented, disclosed embodiments can create a proxy override object that corresponds to an instance of a proxy body within a subpart.

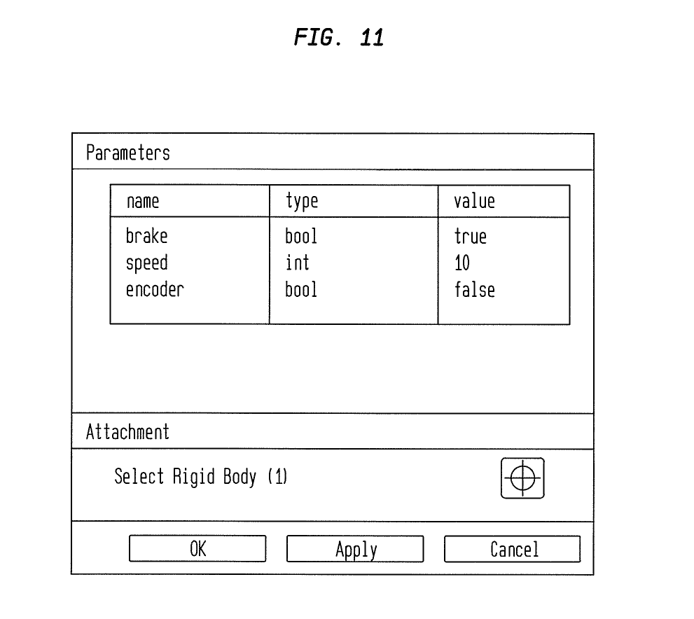

FIG. 11 illustrates an example dialog for setting the attachment of a proxy override as disclosed herein. If a part is included multiple times in the same assembly that has a proxy body, a unique proxy override may be created for that proxy body for each part. For example, in FIG. 3, the work part 300 is the top-level assembly. The component part 1 301 (shown in detail in FIG. 6) with the cylinder head 602 defines a proxy body named Proxy Block 610. Thus, in the work part assembly, it is possible to create up to three proxy override objects for the Proxy Block proxy body. One for the proxy provided by the master piston, and two more, one for each regular piston.

The proxy override allows the user to set the attachment to the rigid body that is desired, as shown in FIG. 11. Since a proxy body can stand in for a rigid body, it is also possible for the attachment to be set to another proxy body. The system can check to prevent the user from forming loops where proxy overrides point to each other in a chain coming back to oneself. It is not necessary to prevent loops though. Loops can be detected at runtime and can be interpreted as not being connected to any real rigid body in that case.

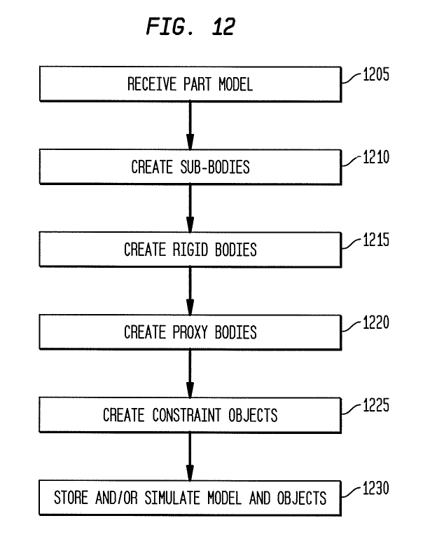

Runtime Behavior: Although proxy bodies themselves are typically not active elements during simulation runtime, their semantics affects the behavior of other objects. The order in which various physics objects are created is shown in FIG. 12. First, sub-bodies like collision surfaces and triggers are created. These objects are created first because their use is dictated by whether rigid bodies will cause them to move. Second, the rigid bodies are created. The rigid bodies will tie in to the collision surfaces and triggers they affect and are created before proxy bodies so that those proxies attached to a rigid body will be able to find the rigid bodies to which they are attached. Third, the proxy bodies are created. The attachment fields of proxy overrides are used to determine which proxy bodies will be converted to rigid bodies. If the attachment points to another proxy body, the chain of proxies is followed until a rigid body is discovered; the chain ends with an empty attachment; or the chain loops back to an earlier proxy body. In the second two cases, the proxy body acts as a static object with no movement physics applied to other objects that reference it. In the first case, the rigid body is tied to the proxy body as its value. Joints that refer to the proxy will be made to use the rigid body. Sub-bodies that share geometry with the proxy will be treated as sharing geometry with the rigid body.

The mass properties of the proxy body can be computed using the list of geometric elements in the proxy body's set up. When a proxy is attached to a rigid body, the mass properties of the proxy are added to the mass properties of the rigid body. This includes both linear inertial mass and rotational moment of inertia. When multiple proxy bodies are attached to a single rigid body, the mass properties of each proxy can be added independently to produce a total sum. It is also possible to ignore the mass properties of the proxy body and not add such properties to the rigid body if the simulation accuracy is not critical.

The fourth stage of object creation produces joints and constraints for the simulation. Since the proxy bodies are tied to a particular rigid body in the previous step (or determined to be static), the actual rigid body can be associated with the joint that references a proxy body.

The simulation effects of the proxy during runtime may be just a method to hold data without necessarily causing any particular physics to be calculated. One possible effect is to allow the attachment value of the proxy to change during simulation. In this case, the sub-bodies and the joints that share reference with the proxy body need to be transferred to whatever rigid body is pointed to by the attachment. Since attachments can point to other proxy bodies, the same search process for finding the end of the chain or a loop would need to be applied. The mass properties of the proxy body can be used to affect the mass properties of the attached rigid bodies. When the attachment changes from one body to another, the mass properties of the proxy body can be subtracted from the rigid body to which it was originally attached and added to the new rigid body that the proxy becomes attached to. If there is no new attachment, the referenced sub-bodies and joints become background static. Likewise, if a proxy body had originally no attachment, but later is attached to a rigid body, the static properties of the sub-bodies and joints become dynamic.

Copying During Simulation: The runtime simulation may allow physics objects to be copied while the simulation is running. This may occur for single objects or for groups of objects at once. For example, the system may allow all the physics stored in a given component part to be copied during simulation to provide dynamically generated objects for other elements of the simulation to interact with.

If proxies are defined in the set of objects to be copied, the proxy object itself may be copied as physics objects would be. Since proxy object may store other data besides attachments to a rigid body, the parameters of the proxy may be copied so that formulas or other simulation behavior may store values there and likewise transport those values to other objects.

Since the proxy body may be in a separate component from the rigid body to which it is attached, it is possible for one or the other to be copied during the simulation without copying the other. A typical interpretation if both objects get copied together is that the attachment of the proxy body will be transformed into a reference to the copy result of the rigid body. Hence, the element of the proxy body, such as connected joints and sub-bodies will likewise transfer. If the proxy body is copied but not the rigid body, then the new proxy body can be considered to have no attachment value. The connected joints and sub-bodies will be made static. It is also possible to interpret the copy in this case as the new proxy also being attached to the original rigid body. The connected joints and sub-bodies would then be connected to the original rigid body and the mass properties of the proxy body would be added to the mass properties of that rigid body. If the rigid body is copied without copying an attached proxy body (some proxy bodies may be copied and others not), then the connections from that proxy body are not transferred to the new rigid body. The rigid body will be copied from the original but the elements corresponding to the proxy connected elements necessarily be copied as well.

Disclosed embodiments can be used, in particular, in a CAD or PDM data processing system that supports reuse of parts via a tree of connected data or files. It allows connections to rigid body objects to be made indirectly through the use of proxy body objects that are stored locally in a reusable part. When instantiating the part in an assembly, the proxy body can be linked to an actual rigid body via the proxy override object in any part that is in the scope of the assembly. Disclosed embodiment can also be used in any system that allows objects to be stored locally with the parts or be associated with specific parts, where these objects have referential properties such that objects are linked with other objects to set the semantics of the tool.

FIG. 12 depicts a flowchart of a process in accordance with disclosed embodiments that may be performed, for example, by a CAD, PLM, or PDM system.

The system receives a part model (1205). Receiving, as used herein, can include loading from storage, receiving from another device or process, receiving via an interaction with a user, or otherwise.

The system can create sub-bodies corresponding to the part model (1210). These sub-bodies can include collision surfaces and triggers and can be associated with respective elements of the part model. The sub-bodies can be created during a user interaction. When an object is referred to as “corresponding to” the part model as described herein, that object will generally be in or part of the part model, but may be maintained as a separate object with a defined relationship to some or all of the part model.

The system creates one or more rigid bodies corresponding to the part model (1215). The rigid bodies can be created during a user interaction and can be associated with respective elements of the part model. The rigid bodies can be associated with respective ones of the collision surfaces and triggers, and the rigid bodies can define the use and movements of their associated sub-bodies.

The system creates one or more proxy bodies associated with part model (1220). The proxy bodies can be created during a user interaction. The proxy bodies can represent rigid bodies that are not part of the part model, but are rigid bodies with which the part model interacts. This step can include directly attaching rigid bodies or other bodies of the part model to respective proxy bodies. This step can include converting a proxy body to a rigid body; the attachment fields of proxy overrides can be used to determine which proxy bodies will be converted to rigid bodies.

If the attachment points to another proxy body, the chain of proxies can be followed until a rigid body is discovered; the chain ends with an empty attachment; or the chain loops back to an earlier proxy body. In the second two cases, the proxy body acts as a static object with no movement physics applied to other objects that reference it. In the first case, the rigid body is tied to the proxy body as its value. Joints that refer to the proxy will be made to use the rigid body. Sub-bodies that share geometry with the proxy will be treated as sharing geometry with the rigid body.

This step can include assigning mass properties to the proxy body that is computed using a list of geometric elements in the proxy body's set up. When a proxy is attached to a rigid body, the mass properties of the proxy are added to the mass properties of the rigid body. This includes both linear inertial mass and rotational moment of inertia. When multiple proxy bodies are attached to a single rigid body, the mass properties of each proxy can be added independently to produce a total sum. It is also possible to ignore the mass properties of the proxy body and not add such properties to the rigid body if the simulation accuracy is not critical.

The system creates constraint objects (1225). The constraint objects can include joints, constraints, and other objects used for the simulation. Since the proxy bodies can each be attached to a particular rigid body in the previous step (or determined to be static), the actual rigid body can be associated with the joint that references a proxy body.

The system can then store the part model and associated sub-bodies, rigid bodies, proxy bodies, and constraint objects. The system can re-use the part model and associated sub-bodies, rigid bodies, proxy bodies, and constraint objects in other models or assemblies. The system can simulate the part model according to the associated sub-bodies, rigid bodies, proxy bodies, and constraint objects (1230). The simulation effects of the proxy during runtime may be just a method to hold data without necessarily causing any particular physics to be calculated.

Disclosed embodiments provide new ways to model a simulation system. They enable a more convenient reuse scenario. Using techniques as described herein, users can build their test parts more easily and it also gives the users the opportunity to swap the objects in the upper assembly without changing the reuse component parts already in production.

Since instances of the proxy body can have different behaviors than the original proxy body, users can save time and costs in modeling. The reuse aspect of disclosed embodiments can greatly increase productivity. Users do not need to reconstruct the simulation models. Users can leverage parts built in the simulation part library to build more complex assemblies or perform the “what if” studies. Users can simply attach the physics object in the upper assembly to the proxy object from the reuse part and perform the necessary studies.

Other commercial simulation software do not have similar capabilities. Users would need to construct a specific simulation model for each study.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for part model simulation, the method performed by a data processing system and comprising:
receiving a part model in the data processing system;
creating at least one rigid body corresponding to the part model;
creating at least one proxy body corresponding to the part model, including directly attaching at least one proxy body to at least one rigid body, wherein the proxy body represents a rigid body that is not part of the part model; and
simulating the part model by the data processing system according to the corresponding rigid bodies and proxy bodies.

2. The method of claim 1, wherein the data processing system also creates at least one sub-body corresponding to the part model, simulating the part model is also performed according to the sub-body, and each sub-body is a collision surface or a trigger.

3. The method of claim 2, wherein at least one rigid body is associated with at least one respective sub-body and defines the movement of the associated sub-body.

4. The method of claim 1, wherein the data processing system also creates at least one constraint object corresponding to the part model and simulating the part model is also performed according to the constraint object.

5. The method of claim 1, wherein the data processing system also converts a proxy body to a rigid body according to an attachment field of a proxy override.

6. The method of claim 1, wherein the data processing system attaches the at least one proxy body to the at least one rigid body by following a chain of proxy bodies until the at least one rigid body is discovered.

7. The method of claim 1, wherein the data processing system also assigns mass properties to the at least one proxy body that are computed using a list of geometric elements in the respective proxy body's set up.

8. A data processing system comprising:
a processor; and
an accessible memory, the data processing system particularly configured to receive a part model;
create at least one rigid body corresponding to the part model;
create at least one proxy body corresponding to the part model, including directly attaching at least one proxy body to at least one rigid body, wherein the proxy body represents a rigid body that is not part of the part model; and
simulate the part model according to the corresponding rigid bodies and proxy bodies.

9. The data processing system of claim 8, wherein the data processing system also creates at least one sub-body corresponding to the part model, simulating the part model is also performed according to the sub-body, and each sub-body is a collision surface or a trigger.

10. The data processing system of claim 9, wherein at least one rigid body is associated with at least one respective sub-body and defines the movement of the associated sub-body.

11. The data processing system of claim 8, wherein the data processing system also creates at least one constraint object corresponding to the part model and simulating the part model is also performed according to the constraint object.

12. The data processing system of claim 8, wherein the data processing system also converts a proxy body to a rigid body according to an attachment field of a proxy override.

13. The data processing system of claim 8, wherein the data processing system attaches the at least one proxy body to the at least one rigid body by following a chain of proxy bodies until the at least one rigid body is discovered.

14. The data processing system of claim 8, wherein the data processing system also assigns mass properties to the at least one proxy body that are computed using a list of geometric elements in the respective proxy body's set up.

15. A non-transitory computer-readable medium encoded with executable instructions that, when executed, cause one or more data processing systems to:
receive a part model;
create at least one rigid body corresponding to the part model;
create at least one proxy body corresponding to the part model, including directly attaching at least one proxy body to at least one rigid body, wherein the proxy body represents a rigid body that is not part of the part model; and
simulate the part model according to the corresponding rigid bodies and proxy bodies.

16. The computer-readable medium of claim 15, wherein the data processing system also creates at least one sub-body corresponding to the part model, simulating the part model is also performed according to the sub-body, and each sub-body is a collision surface or a trigger.

17. The computer-readable medium of claim 16, wherein at least one rigid body is associated with at least one respective sub-body and defines the movement of the associated sub-body.

18. The computer-readable medium of claim 15, wherein the data processing system also creates at least one constraint object corresponding to the part model and simulating the part model is also performed according to the constraint object.

19. The computer-readable medium of claim 15, wherein the data processing system also converts a proxy body to a rigid body according to an attachment field of a proxy override.

20. The computer-readable medium of claim 15, wherein the data processing system attaches the at least one proxy body to the at least one rigid body by following a chain of proxy bodies until the at least one rigid body is discovered.
